(19) United States
(12) Patent Application Publication
(10) Pub. No.: US 2023/0281726 A1
(43) Pub. Date: Sep. 7, 2023

(54) STATUS REPORTING SYSTEM FOR AIRCRAFT

(71) Applicant: Scott Beale, Mayfield Heights, OH (US)

(72) Inventors: Neil Butara, Mayfield Heights, OH (US); Scott Beale, Mayfield Heights, OH (US); Lance Warren, Mayfield Heights, OH (US)

(21) Appl. No.: 17/683,992

(22) Filed: Mar. 1, 2022

(51) Int. Cl. G06Q 40/00; G08G 5/00

(52) U.S. Cl. CPC G06Q 40/123; G06Q 40/10; G08G 5/0043

(57) ABSTRACT

A taxability status system determines a taxability status for aircraft according to selected jurisdictions including a state or a county. The system receives traffic control system information, transponder data and assessor data to provide a taxability status report and updated reports in order to assess and verify where taxes have or have not been paid. The system further determines gap related information that can be identified within the traffic control system information as a result of mismatching departure and arrival data at airport jurisdictions.

### FIELD

The present disclosure relates generally to monitoring an aircraft, and more specifically, pertains to techniques for reporting location and other status for the aircraft to governmental authorities.

### BACKGROUND

Transportation continues to be vital in our daily lives. People and goods often travel using commercial vehicles such as aircraft, boats, trains, and motor vehicles. While airlines carry a majority of air passengers, a considerable number of passengers travel via general aviation aircraft such as business jets. Recent reports have indicated that general aviation adds up to 1.1 million jobs and contributes over $200 billion to the U.S. economy. General aviation enables businesses to enable face-to-face contacts which can be vital for certain businesses. In addition to business travel, general aviation can provide other vital services, such as emergency medical flights, aerial firefighting flights, law enforcement flights, flight training, time-sensitive cargo flights, aerial photography/surveillance, personal travel, as well as agricultural functions.

Recent reports indicate that there are about 15,000 business aircraft registered in the United States. A “Business aircraft” is defined as fixed-wing turbine aircraft plus piston (single and twin engine) general aviation aircraft and flown as business or corporate operations as determined by the Federal Aviation Administration (FAA). About 3 percent of these aircraft are flown by Fortune 500 companies, while the remaining 97 percent encompass a broad cross-section of operators that are primarily businesses of all sizes. Business aircraft operators are registered in every state in the country.

People and companies that rely on business aviation represent many different professions and locations, but they all share the need for fast, flexible, safe, secure and cost-effective access to destinations across the country and around the world. In many instances, business aviation is the appropriate transportation solution, opening the door to global commerce for small-community and rural populations by linking them directly to population centers and manufacturing facilities.

### SUMMARY

Disclosed aspects provide a transient asset tax recovery system that is developed for aircraft including private, business and commercial assets with particular attention towards private / business turbine assets with higher dollar amounts. The unique and primary function of disclosed aspects is to utilize the Federal Aviation Administration (FAA) historical Air Traffic Control (ATC) database and the patent algorithms to determine the aircraft tax jurisdiction first and then determine which taxpayers have not paid historical tax (previous taxes) or have underreported /underpaid taxes. The data mining software system integrates over eight databases (listed below) to determine aircraft identification with owner, asset tax jurisdiction, historical tax paid/unpaid, asset valuation, estimated tax owed and reporting information. The system end result and benefit is to recovery unpaid and underpaid taxes on behalf of government entities which include property taxes, sales and use tax, commercial operations tax, lease taxes, apportionment taxes and a host of registration type tax. At least half of the continental United States have no significant property tax (i.e., Ohio), while the other half have significant property taxes which can reach over $20,000 per $1 million in value per year. The state property tax inconsistency often influences the taxpayer to misreport their aircraft in a state which has no property tax ultimately avoiding the tax. Due to the transient nature of aircraft, single government entities with limited resources and not working together with other entities struggle to identify the aviation taxes, evaluate the aircraft and recover taxes.

In an aspect, a system for providing a taxability status report of one or more aircraft can include a transponder transceiver, which can be proximate to an airport. The transponder receiver can be configured to receive transponder data from a transponder on an aircraft. The transponder data, for example, can include altitude data, speed data, along with other aviation parameters, including aircraft type, make, model, an aircraft ID (e.g., call sign or tail number), or other aviation parameter. The system can include a memory that stores computer-executable components or computer-executable instructions as well as a processor that is communicatively coupled to the memory. The processor can be configured to execute the computer-executable components or the computer-executable instructions, to at least: receive traffic control system information associated with the aircraft from a first database; determine whether a gap between a departure and an arrival of the aircraft is in the traffic control system information, wherein the gap comprises a mismatch between a departure location of the aircraft and an arrival location of the aircraft that indicates a missing time and a missing location of the aircraft at the airport; in response to determining a gap is in the traffic control system information, determine the missing time and the missing location based on the transponder data; generate a taxability status report of the aircraft based on the traffic control system information, the missing time and the missing location; and receive assessor data associated with a period of time that overlaps with the gap from at least one second database. The assessor data can include tax data associated with the aircraft that is indicative of taxes paid in relation to at least one of the airport, the gap, a state or a county.

In another aspect, a method for a taxability status report of an aircraft can comprise receiving, by a system including at least one processor, traffic control system information associated with an aircraft from a first database. A determination can be made as to whether a gap occurs between a departure location of the aircraft and an arrival location of the aircraft that indicates missing data, including a missing time and a missing location of the aircraft at an airport. Transponder data can be received from a transponder mounted on the aircraft by a transceiver positioned in proximity to the airport, or a device component communicatively coupled thereto. In addition, assessor data associated with a period of time that overlaps with the gap can be received from at least one second database. The assessor data can comprise tax data associated with the aircraft that is indicative of paid taxes or a registration being paid or occurring in relation to at least one of a state, a county, the airport, the gap, an unaccounted gap, or other jurisdiction. The missing time and the missing location can be determined or estimated in association with information pertaining to the gap based on the transponder data and the assessor data. A taxability status report of the aircraft can be generated based on the traffic control system information and the missing time and the missing location. A cross-check of the taxability status report can be performed with the assessor data across a plurality of jurisdictions comprising at least one of: the airport, a state or a county for the aircraft, wherein the assessor data comprises tax data associated with the aircraft indicative of the taxes paid in relation to the plurality of jurisdictions. An updated taxability status report is generated based on the cross-check.

In yet another aspect, a non-transitory computer readable storage medium configured to store computer executable instructions or executable components that, in response to execution, cause a computing system including at least one processor to perform operations. The operations can comprise receiving traffic control system information associated with one or more aircraft from a first database, transponder data associated with one or more airports and the one or more aircraft, and assessor data of assessed taxes in a period of time associated with one or more states or counties. The operations further include determining whether a gap is present with the traffic control system information. The gap can comprise a mismatch between a departure location and an arrival location of the one or more aircraft indicative of a missing time and a missing location at the one or more airports from among the traffic control system information, the transponder data, and the assessor data. In response to determining the gap is present, determining the missing time and the missing location based on at least one of: the transponder data or the assessor data. A taxability status report of the one or more aircraft can be generated based on the traffic control system information and the transponder data with an evaluation of taxes unpaid or paid across a plurality of jurisdictions associated with the one or more aircraft. Then a cross-check of the taxability status report can be performed with the assessor data across the plurality of jurisdictions, wherein the plurality of jurisdictions comprises the one or more airports, states or counties. An updated taxability status report can be generated based on the cross-check.

### BRIEF DESCRIPTION OF THE DRAWINGS

The structure, operation, and advantages of the present disclosure will become further apparent upon consideration of the following description taken in conjunction with the accompanying figures (FIGs.). The figures are intended to be illustrative, not limiting.

Certain elements in some of the figures can be omitted, or illustrated not-to-scale, for illustrative clarity. The cross-sectional views can be in the form of “slices”, or “near-sighted” cross-sectional views, omitting certain background lines which would otherwise be visible in a “true” cross-sectional view, for illustrative clarity. Furthermore, for clarity, some reference numbers can be omitted in certain drawings.

FIG. 1 illustrates an example system for generating a taxability status report in accordance with various aspects.

FIG. 2 illustrates an example of multiple jurisdictions for generating a taxability status report in accordance with various aspects.

FIG. 3 illustrates an example of traffic control system data for generating a taxability status report in accordance with various aspects.

FIG. 4 illustrates an example block diagram of a remote transponder sensing unit in accordance with various aspects.

FIG. 5 illustrates an example process flow of acts associated with generating a taxability status report in accordance with various aspects.

FIG. 6 illustrates another example process flow of acts associated with generating a taxability status report in accordance with various aspects.

FIG. 7 illustrates an example computing device for generating a taxability status report in accordance with various aspects.

FIG. 8 illustrates another example process flow of acts associated with generating a taxability status report in accordance with various aspects.

FIG. 9 illustrates another example process flow of acts associated with generating a taxability status report in accordance with various aspects.

FIG. 10 illustrates an example vehicular asset taxability status report in accordance with various aspects.

FIG. 11 is a block diagram representing exemplary non-limiting networked environments in which various aspects described herein can be implemented.

### DETAILED DESCRIPTION

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure will now be described with reference to the attached drawing figures, wherein like (or similarly ending) reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), or firmware. For example, a component can be a processor (e.g., a microprocessor, a controller, or other processing device), a process running on a processor, a controller, an object, an executable, a program, a storage device, a computer, a tablet PC or a user equipment (e.g., mobile phone, etc.) with a processing device. By way of illustration, an application running on a server and the server can also be a component. One or more components can reside within a process, and a component can be localized on one computer or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local or remote processes such as in accordance with a signal having one or more data packets (e.g., data from one component interacting with another component in a local system, distributed system, or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

In consideration of the above, various aspects / aspects are disclosed for generating taxability status reports that locate, identify, discover, valuate, and determine the tax liability across the national fleet of aircraft. Aircraft are a transitive asset thus making it difficult to locate as they move often and are hard to accurately measure the pertinent information used in determining proper jurisdiction and tax liability. Aircraft owners at times have had the ability to mask and hide their movements to avoid taxation using many methods to avoid detection, while local governments often lack the ability to search, discover, find, and prove that aircraft meet the requirements for taxation inside their area. Especially when it comes to appealing a tax bill, the county assessors have long lacked the ability to generate accurate data, measurements, and perform the necessary functions to maintain accurate tax rosters and defend the tax code.

In an aspect, a system for generating taxability status reports can be configured dynamically to import from many different sources to create a comprehensive database with the function of assessing aircraft tax liability. The reports with the database(s) can identify the appropriate aircraft that have tax liability in a jurisdiction, and then produce all of the necessary reports, measurements, and valuation methods that the local government can need to apply the tax code

General aviation aircraft such as business jets can cost orders of magnitude more than a typical automobile. Some modern business jets can be valued in the hundreds of millions. These aircraft rely on the infrastructure provided by airports and air traffic control (ATC) facilities throughout the country. Tax jurisdictions such as states, counties and municipalities collect a variety of taxes from the aviation community to support this infrastructure. There are a variety of taxes and fees that can be assessed. For example, there are use taxes, which are a function of how often an aircraft uses a particular airport. Additionally, there are property taxes or registration fees that are a function of where the aircraft has spent a significant amount of time, as well as the value or type of aircraft.

Some of the taxes assessed can include, but are not limited to, the following: 1) Property or Ad Valorem Tax; 2) Sales and Use Tax; 3) Apportioned taxes for commercial and multi-state based operators; 4) Lease and Commercial Operations tax; 5) Aircraft parts and maintenance tax; 6) Aviation fuel tax; and 7) Airport landing, registration and other fees, as well as any exemption or tax code considerations.

Because aircraft are relatively expensive, the tax liability owed to a jurisdiction can be significant. However, because aircraft are movable assets, accurate assessment of tax liability can be challenging. In some states property taxes can mount up annually to a significant amount. States that impose property taxes on aircraft include California, Georgia and Wyoming. Recent information indicates that there are over twenty states that impose some sort of property tax. As with real estate, property taxes on aircraft are usually levied at the local level. Even states that don’t have a “property” tax on aircraft per se can have a similar tax under another name, such as a tax on “assets owned by businesses” or “income-producing assets.”

Aircraft registration fees are typically charged in place of a property tax, although Utah and a few other states charge both. One way for a state to stay on top of collecting sales and use tax on aircraft hangared within its borders is to require the aircraft to be registered. Thus, tax liability for aircraft is an extremely complex matter, as different jurisdictions have different rules, and different criteria for when those rules apply in accordance with various tax codes.

The Air Traffic Control (ATC) system records data of filed flight plans and actual air traffic radar hits. The FAA SWIM Flight Data Publication Service (SFDPS) makes such data available to a limited audience. However, merely tracking this data is insufficient to gain a full picture of aircraft activity as it pertains to taxes. There can be gaps in the ATC data. The most common instance of this occurs when an airplane flies to another airport under visual flight rules (VFR). In such an instance, it is possible for an aircraft to move to another tax jurisdiction without creating an indication of the activity within the ATC data. Further complicating the tracking is that ATC data can sometimes use call signs in place of an aircraft registration number (i.e. “N-number”). Thus, it can be very challenging to obtain an accurate record of aircraft activity simply by examining ATC data.

Disclosed aspects provide a solution that allows tax jurisdictions such as states, counties, cities, and other regional jurisdictions to obtain detailed information about aircraft activity and identify potentially owed taxes via taxability status reports generated by the system 104, for example. This can enable the jurisdictions to collect the revenues they are owed, which enables continued maintenance of the airport infrastructure, as well as dynamically update information with assessor data from various jurisdictions on an ongoing basis.

Disclosed aspects provide techniques for determining a taxability status for a vehicular asset, such as an aircraft. The techniques include obtaining traffic control system information for the vehicular asset, detecting gaps in traffic control system information for the vehicular asset, and recording the gaps, computing a primary location for the vehicular asset based on the traffic control system and remote transponder sensing unit’s information, and creating a vehicular asset taxability status report for the vehicular asset, where the report includes the primary location and gap information. Additional aspects and details of the disclosure are further described below with reference to figures.

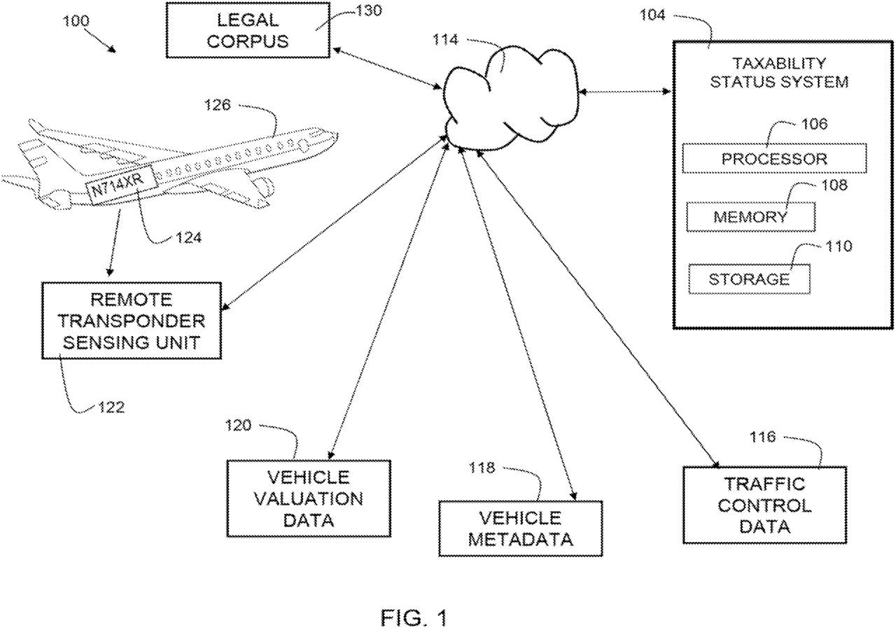

FIG. 1 shows a system 100 for reporting a taxability status for aircraft in one or more jurisdictions in accordance with aspects herein. System 100 includes a taxability status system 104 that is configured to generate taxability status reports based on a selected aircraft, airport, county, state, or other jurisdiction. In an aspect, the taxability status system 104 can be implemented as a computer comprising a processor 106, and memory 108 coupled to the processor. The memory 108 can be a non-transitory computer readable medium. Memory 108 can include RAM, ROM, flash, EEPROM, or other suitable storage technology. The memory 108 contains instructions, that when executed by processor 106, enable communication with a variety of other devices and data stores. In aspects, network 114 can include the Internet.

The taxability status system 104 can communicate with an air traffic control data source 116. The air traffic control data source 116 can include data from the FAA SWIM Flight Data Publication Service (SFDPS). The air traffic control data can include, but is not limited to, a departure airport, an arrival airport, a departure date, a departure time, an arrival date, an arrival time, an aircraft type, a registration number, a call sign or the other traffic control system information. The registration number can serve as a vehicle identification number or tail number for the aircraft. The air traffic control data from the air traffic control data source 116 can be referred to as traffic control information, traffic control system information, or the like.

The taxability status system 104 can communicate with a vehicle metadata source component 118. The vehicle metadata source component 118 can include FAA vehicle registration data. The vehicle metadata can include, but is not limited to, a vehicle serial number, an aircraft manufacturer name, an aircraft model (vehicle model type), an aircraft type, a year of manufacture for the aircraft (vehicle manufacture date), registered owner information, an engine manufacturer, or a vehicle engine type in addition to a significant amount of the vehicle specifications, equipment and statistics on said aircraft for purposes of evaluating the aircraft once jurisdiction is determined.

The taxability status system 104 can be communicatively coupled with a vehicle valuation source component 120. The vehicle valuation source component 120 can include data from one or more subscription-based services to provide an estimate of current value based on individual aircraft details. Such services can include, but are not limited to, the Aircraft Blue Book and VREF valuation guides. The current value or estimated market value derived by the system 104 can be used as part of tax liability assessment in certain cases, depending on the rules and regulations of a particular tax jurisdiction. In addition, the JETNET and AMSTAT® services can be utilized, which are aircraft databases that keep records on each and every aircraft for the system 104 to include owner information, operator information, pilot/Chief Pilot information, manufactured year, aircraft equipment and specifications, airframe/engine times, pictures of the aircraft and interior, etc., for generating a taxability status report. The information in this system provides all of the particular details which feed the VREF, AMSTAT and an Appraisal database.

The data from the sources 116, 118, and 120 can be stored within storage 110. In aspects, a database format such as a structured query language (SQL) format, or other format, could be used to store the data. In various aspects, data can be filtered, output or exported in a different format, such as in comma separated values (CSV), to enable processing by spreadsheets or other programs, including in Word, Excel, PDF, or other particular document type. As such, the taxability status report of an aircraft or aircraft of a jurisdiction can be generated on an ongoing basis with updated information for an updated date range.

The system 100 can optionally include one or more remote transponder sensing units 122. The remote transponder sensing unit 122 is an electronic device that is installed in proximity to an airport such that it can detect transponder information from an aircraft 126 where the information includes a registration number 124 that is associated with the aircraft 126. The data from the remote transponder sensing unit 122 can be used to reconcile gaps in the air traffic control system information. In aspects, the remote transponder sensing unit 122 can receive information from an automatic dependent surveillance-broadcast (ADS-B) transponder, and receive data from or interrogate a mode S transponder, or a mode C transponder. The transponder can be installed on an aircraft as part of its electronic safety equipment. It can broadcast an identifying code such as a registration number or other code that is linked to a registration number. In some aspects, the remote transponder sensing unit can interrogate the transponder in order to receive a reply from the transponder containing information or parameters related to a flight leg or at least a portion of a flight from takeoff to landing. The transponder information can further include surveillance information such as altitude, flight level, speed information, an identification of an aircraft (e.g., tail number, call sign, or the like), emergency signaling, alerts, failed equipment, flight plan deviation(s), or other flight related information to the aircraft. In one aspect, the altitude and speed information can be used to confirm that the aircraft in question was taking off or landing at an airport. The transponder information can further include other aviation parameters, including, but not limited to, aircraft type, latitude, longitude, heading, or other aviation parameters. The transponder information can be utilized by the taxability status system 104 for determining missing data in the traffic control system information, such as where a gap in aircraft data pertaining to a location and time, or related information evidence of a tax status for a particular jurisdiction (e.g., airport, state, county, or the like).

The system 100 can further be communicatively couple to a legal corpus 130 and communicate with the legal corpus 130 to access laws, rules, regulations, tax rates, and other information that can be used to determine computer-implemented automated estimated tax liabilities or a tax status for a particular jurisdiction in the generation of a taxability status report. The legal corpus 130 can further include title or ownership information including registrations, chain of sales, pending suits, holds, chain of owner information, liens, other encumbrances, together with location information, addresses, or the like. This can be used in the generation of the taxability status report for determining location(s), verification(s), paid / unpaid taxes, or registrations therein. The legal corpus information can be used together with traffic control system information, and transponder information to allow convenient notification of jurisdiction authorities regarding potentially owed tax revenue from aircraft operators or owners based on evidence derived by one or more taxability status reports with the system 104 for a particular aircraft, or list of aircraft in one or more jurisdictions.

Aspects combine data from the traffic control data source 116, vehicle metadata 118, vehicle valuation data 120, or remote transponder sensing unit 122 data to reconcile gaps in the traffic control data. The system 100 can then compute a primary location for the purposes of property taxes, and estimate, based on information from legal corpus data 130, a tax liability that is owed to that jurisdiction for the aircraft 126. In the event, that the aircraft has primary locations which share tax reciprocity and apportionment, the system can determine the prorate share to the multiple jurisdictions.

Other aspects can include obtaining assessor information on paid taxes / paid registration fees, or taxes / fees assessed by county assessor(s) from another data base. County-level assessor data can be used by the system 104 to identify where taxes have already been paid. The assessor information/data can include identification of aircraft (e.g., tail number, call sign, etc.), make, model, valuations, improvements, maintenance history, maintenance cost, owner address, associated service rentals (e.g., hangar address, towing use / address, other service locations / information), exemption information, duration of storage or location over a period, property description / use (e.g., commercial, private, etc.), or other assessment data at the county level over a given history or current data range. The system 104 can operate to cross-reference the taxability status report based on traffic control system information, detected gap(s) (in a location presence, continuity of data, taxes paid, etc.), transponder data, or legal data from a first database with assessor information from one or more counties / states from a second database. The cross-referencing can include cross-checking or verifying taxes unpaid / paid or registration fees from a plurality of aircraft within a jurisdiction according to confidence scores, for example, with respect to a particular aircraft and a jurisdiction in the taxability status report or an updated taxability status report.

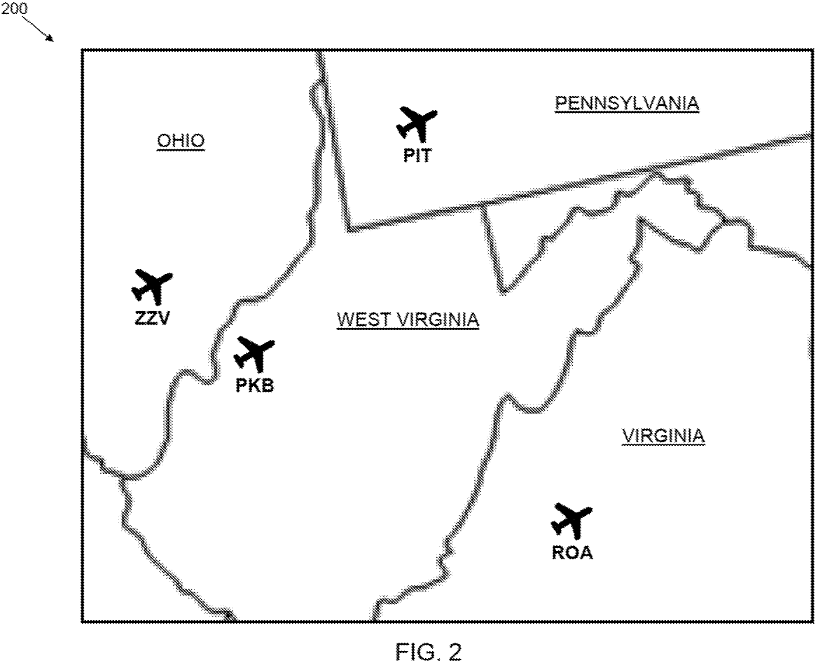

FIG. 2 shows examples of multiple jurisdictions. The map 200 indicates four airports. Airport ZZV corresponds to in Zanesville Municipal Airport in Muskingum County, Ohio. PKB corresponds to Mid-Ohio Valley Regional Airport in Wood County, West Virginia. ROA corresponds to Roanoke Regional Airport, in Roanoke County, Virginia. PIT corresponds to Pittsburgh International Airport Allegheny County, Pennsylvania. For the purposes of illustrating disclosed aspects, each of the states shown with an airport in map 200 is assumed to be a tax jurisdiction with a different tax rate. This information is merely illustrative and is not intended to reflect actual tax information. Furthermore, while in the example, the tax jurisdictions are assumed to be statewide, in practice tax jurisdictions can be counties, cities, or other regions.

For the purposes of example only, it is to be considered that Ohio has a property tax of 1.5 percent of an aircraft value if the aircraft spends 185 days or more hangared in Ohio. It is furthermore to be considered that West Virginia does not levy a property tax on aircraft. It is furthermore to be considered that Virginia levies a use tax of $100 per landing per aircraft. It is furthermore to be considered that Pennsylvania has a property tax of 1 percent of an aircraft value if the owner resides in Pennsylvania. As stated previously, this information is merely illustrative for the purposes of explaining the function of disclosed aspects, and is not intended to reflect actual tax information.

Using the aforementioned example, it can be seen how tax liability can be difficult to assess. Due to actions of the aircraft operator, the aircraft location as indicated by the air traffic control system can not always be indicative of the actual whereabouts of the aircraft. Again, based on the previous example rules for the tax jurisdictions of map 200, it can be possible for an aircraft operator (either intentionally, or unintentionally) to create a situation where tax revenue owed a jurisdiction can go undetected. Because West Virginia may have no aircraft property tax, an aircraft operator can fly an aircraft to PKB with a flight plan, and thus, be indicated in air traffic control system data. The operator can then fly from PKB to ZZV under visual flight rules, and thus reside in Ohio, while appearing to be hangared in West Virginia. Disclosed aspects can identify such conditions by using data from a remote transponder sensing unit. In this example, when the aircraft lands at ZZV, even under VFR conditions, the registration number is detected based on transponder data from the aircraft, retrieved by the taxability status system 104, and considered to be located in Ohio, even though the air traffic control system information does not indicate the VFR trip from PKB to ZZV. In this case, the Ohio tax authorities can receive a report indicating the occurrence so the proper taxes can be collected.

In a similar manner, since Virginia includes a use tax for each landing, if an operator uses VFR to ferry an aircraft from PKB to ROA, and then VFR to again take the aircraft from ROA back to PKB, then the takeoff and landing from ROA has the potential to be unreported. Again, using a remote transponder sensing unit installed in proximity to ROA, the transponder information from the aircraft is recorded, and retrieved by the taxability status system 104, and considered to have landed at ROA in Virginia, even though the air traffic control information does not indicate that the aircraft had travelled to ROA. In this case, the Virginia tax authorities can receive a report indicating the occurrence so the proper taxes can be collected.

In a similar manner, if an aircraft spends 53% of the year hangared at PKB in West Virginia, and 40% of its time hangared at PIT in Pennsylvania, and the owner maintains a Pennsylvania address, then the primary location of the aircraft can be deemed to be Pennsylvania, even though that is not the location where the aircraft was hangared for the most time. Thus, in aspects, computing a primary location comprises: computing a list of airplane storage locations indexed by duration; selecting a primary location based on the owner address and a duration of an airport storage location from the list of airport storage locations, wherein the duration exceeds a predetermined threshold, and wherein the airplane storage location and the owner address are in a common tax jurisdiction.

The system 104 can further operate to import or obtain assessor data from database(s) communicatively coupled to various counties and states, filter through assessor data for aircraft at a particular airport or jurisdiction (county or state), and factor a confidence score for whether taxes or registration fees have been paid accordingly or as identified in a taxability status report that is initially generated. This can enable cross-checking and verification of aircraft and their associated tax status with particular qualities (e.g., model, make, age, or other associated information). The system 104 can thus generate reporting tables that enables cross-checking of data from various counties across the country for determining whether or not an aircraft or asset has paid taxes or registration fees for any given year or other date range. The system 104 can thus generate update taxability status reports on a per aircraft, per county, per state, per airport basis according to historical and current searches of records for cross-verification of payment / registration. In aspect, the assessor data can overlap one or more gaps identified and be used with the transponder information to determine missing location or time information with a confidence level or score according to evidence that taxes / registrations have been historically paid or are being currently paid.

In an aspect, the system 104 can be configured to further generate detailed summary reports to include any aircraft that had evidence of being based or located in a specific state or county, or airport based on transponder information, traffic control system information, and assessor data. The system 104 can operate thus to calculate a factored percentage or confidence score for each aircraft in one or more jurisdictions that enables ranking the aircraft with respect to a level of certainty and related evidence associated with each aircraft.

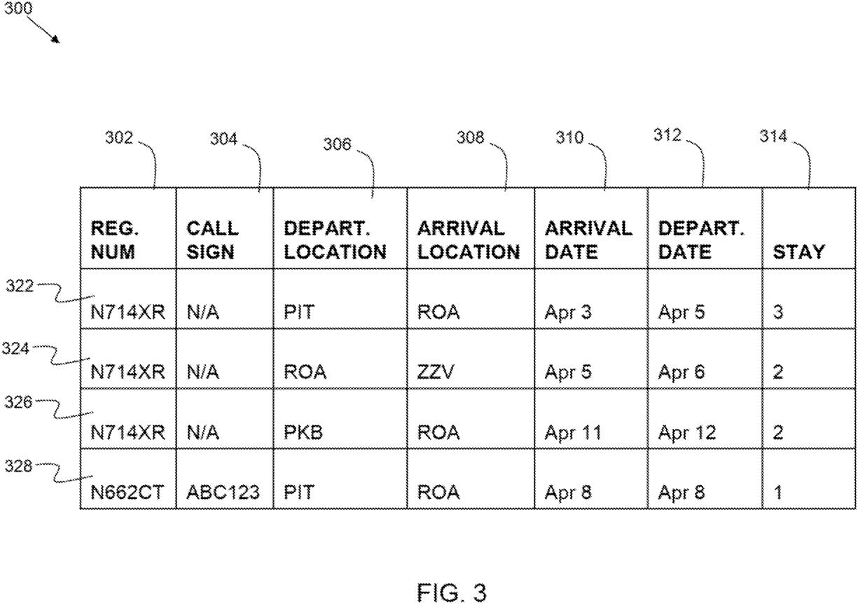

FIG. 3 shows an example 300 of traffic control system data. This data can be stored within taxability status system 104 in a database format, CSV format, binary format, or other suitable data format. Column 302 shows a registration number (also referred to as a “tail number” or “N-number). Column 304 shows a call sign. Not all aircraft use a call sign, but some can use a call sign when interacting with the air traffic control system. Column 306 shows a departure location. Column 308 shows an arrival location. Column 310 shows an arrival date, indicating when the aircraft arrived at an airport. Column 312 shows a departure date, indicating when an aircraft departed an airport. Column 314 indicates a duration/stay at an airport by the aircraft.

Of particular note is the occurrence of gaps in the traffic control system data. For example, rows 322, 324, and 326 all pertain to the same aircraft, having a registration number of N714XR. Row 322 shows record of a flight from PIT to ROA. Row 324 shows the next flight of the aircraft from ROA to ZZV. Row 326 shows the next flight of the aircraft from PKB to ROA. Aspects detect that the departing location of a flight is different than the arrival location of the previous flight of that aircraft, and indicate it as a gap. Thus, a gap occurs when there is a mismatch between the departing location of a flight and the previous arrival of that flight. While it is possible that an aircraft can be moved on land (e.g. by truck) from one location to another, a more typical scenario to explain the gap is that the aircraft made a VFR flight from ZZV to PKB. Again, using a remote transponder sensing unit installed in proximity to airports, the transponder information from the aircraft is recorded, and retrieved by the taxability status system 104, and the VFR flights can be considered so that the proper taxes can be collected. Row 328 shows data for an aircraft that is correlated with a call sign. In this case, the registration number N662CT is correlated with call sign ABC123.

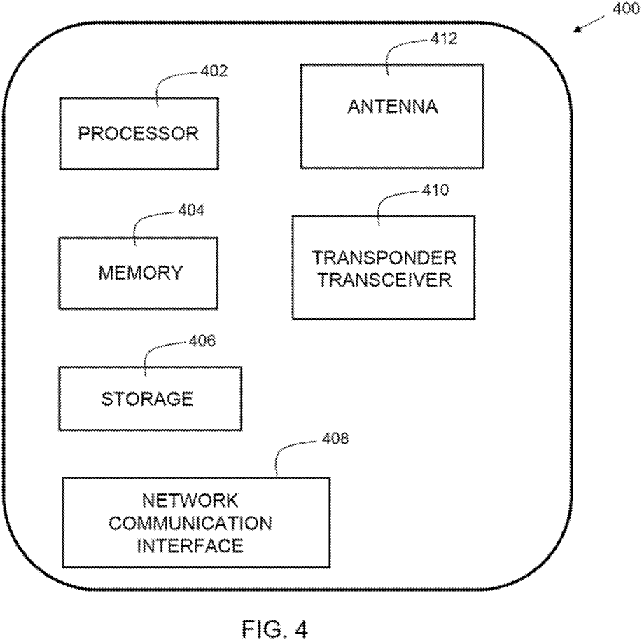

FIG. 4 is a block diagram of a remote transponder sensing unit 400 in accordance with aspects of the present disclosure and can be an example of the transponder unit 122 of FIG. 1. Remote transponder sensing unit 400 includes a processor 402, a memory 404 coupled to the processer 402, and storage 406. The memory 404 can be a non-transitory computer readable medium. Memory 404 can include RAM, ROM, flash, EEPROM, or other suitable storage technology. The memory 404 contains instructions, that when executed by processor 402, enable communication aircraft transponders via transponder transceiver 410. The transceiver is coupled to antenna 412 to enable transmitting or receiving signals from aircraft. Remote transponder sensing unit 400 further includes a network communication interface 408. In aspects, network communication interface 408 includes a wireless communications interface such as a cellular data interface or a Wi-Fi interface. In aspects, the storage 406 stores aircraft activities (such as takeoffs and landings) detected from nearby transponders. The data can then be periodically downloaded by the taxability status system 104 via network communication interface 408. In aspects, the remote transponder sensing unit 400 can be installed near an airport runway, such that it can receive the identifying data from an aircraft transponder as it takes off or lands. In aspects, the remote transponder sensing unit 400 can be used for associating a call sign with an aircraft registration number. For example, if air traffic control data has a record of an aircraft with a call sign of ABC123 landing at the same time that the remote transponder sensing unit 400 detects an aircraft with a registration number of N662CT, then the call sign of ABC123 is associated with the registration number of N662CT. Thus, aspects include associating a call sign with a registration number of the aircraft.

While the methods or process flows are illustrated and described herein as a series of acts (process flow steps, events, or operations), it will be appreciated that the illustrated ordering of such acts are not to be interpreted in a limiting sense. For example, some acts can occur in different orders / concurrently with other acts or events apart from those illustrated / described herein. In addition, not all illustrated acts can be necessarily utilized to implement one or more aspects or aspects of the description in this disclosure. Further, one or more of the acts depicted herein can be carried out in one or more separate acts / phases.

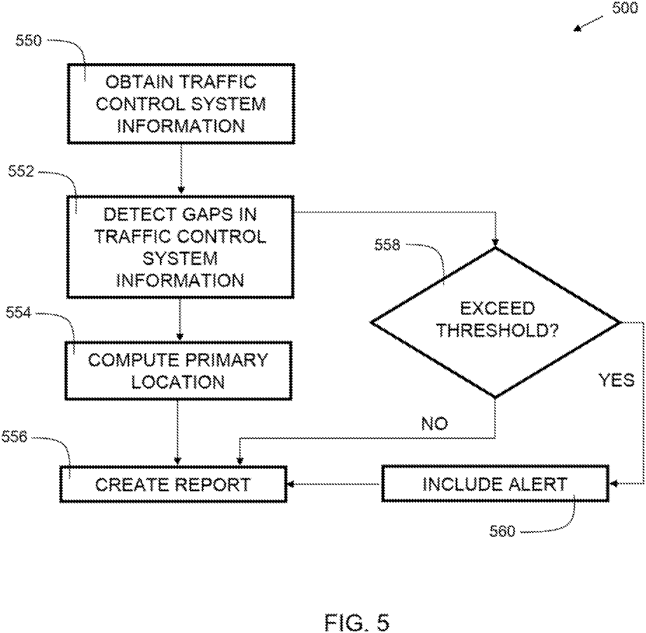

FIG. 5 shows a flowchart 500 indicating process steps for aspects of the present disclosure. In process step 550, traffic control system information is obtained. This can include data from the FAA SWIM Flight Data Publication Service (SFDPS) and well as the Remote Transponder Transceiver. In process step 552, gaps are detected in the traffic control system information. In aspects, this can include performing a check, for a given aircraft, that a departure airport matches the arrival airport of the previous landing. If it does not (as shown in row 326 of FIG. 3), then it is considered as a gap. In process step 554, a primary location is computed. In aspects, the primary location is the location the aircraft is deemed to be hangared at for tax purposes. In process step 558, a check is made to see if the number of gaps detected exceeds a predetermined threshold. If so, then an alert is included at 560, which is included in the vehicular asset taxability status report created at process step 556. The alert provides an indication of possible unrecovered tax revenue, due to gaps that can result in missing tax collection opportunities at various jurisdictions.

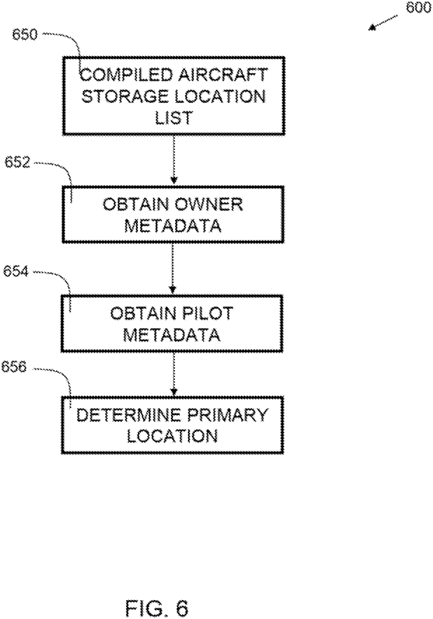

FIG. 6 shows a flowchart 600 indicating a process flow for aspects of the present disclosure. In some cases, the primary location is the location where the aircraft has been hangared for the most time within a given tax period. However, in certain cases, another location can be considered as the primary location depending on place of residence based on domicile, evidence of intent to reside, physical location / address, or other factors. Other metadata, such as owner or pilot residence can be a factor in determining the primary location. In process step 650, an aircraft storage location list is compiled. In aspects, this can include the top three airports or other predefined number of airports where the aircraft spent the most time. In process step 652, owner metadata is obtained. In aspects, the owner metadata can be obtained from FAA registration information as traffic control system information, or other sources. In process step 654, pilot metadata is obtained, if available. In aspects, the pilot metadata can include an address or telephone number for the chief pilot of the aircraft. In process step 656 a primary location is determined. As stated previously, in some cases, the primary location can be augmented with the owner or pilot metadata as well as other data that is evaluated, including assessor data. As in the previously stated example, if an aircraft spends 53% of the year hangared at PKB in West Virginia, and 40% of its time hangared at PIT in Pennsylvania, and the owner has a Pennsylvania address, then the primary location of the aircraft can be deemed to be Pennsylvania, even though that is not the location where the aircraft was hangared for the most time.

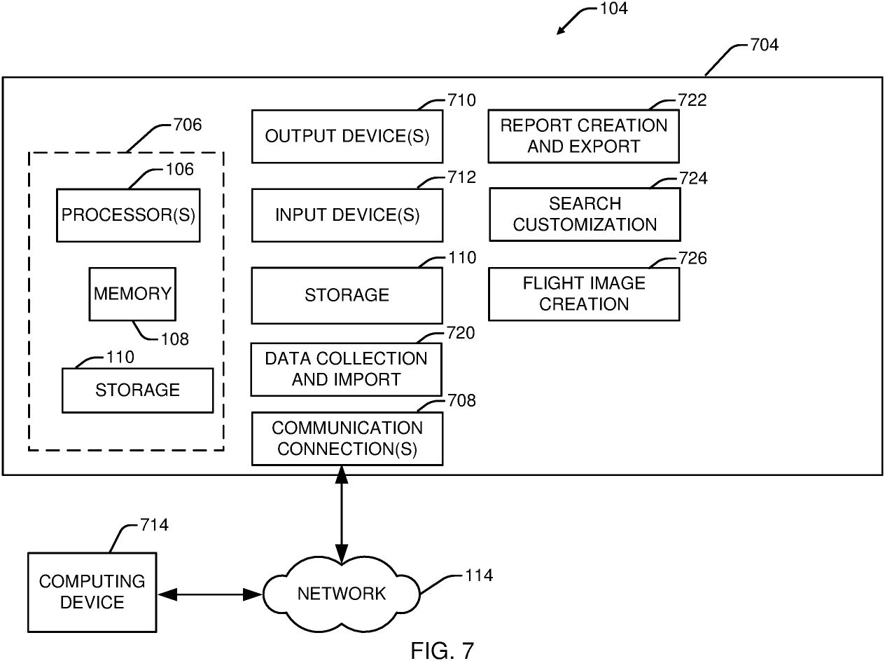

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting aspects, i.e., anywhere that a device can wish to engage on behalf of a user or set of users. Accordingly, the below general purpose remote computer described below in FIG. 7 is but one example of a computing device.

Although not required, non-limiting aspects can partly be implemented via an operating system, for use by a developer of services for a device or object, or included within application software that operates to perform one or more functional aspects of the various non-limiting aspects described herein. Software can be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 7 and the following discussion provide a brief, general description of a suitable computing environment to implement aspects of one or more of the aspects herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, aspects are described in the general context of “computer readable instructions” being executed by one or more computing devices. Computer readable instructions can be distributed via computer readable media (discussed below). Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 7 illustrates another example of the system 104 comprising a computing device 704 configured to implement one or more aspects provided herein. In one configuration, computing device 704 includes at least one processor 106 and memory 108. Depending on the exact configuration and type of computing device, memory 108 can be volatile (such as RAM, for example), non-volatile (such as ROM, flash memory, etc., for example) or some combination of the two. This configuration is illustrated in FIG. 7 by dashed line 706. In other aspects, device 704 can include additional features or functionality. For example, device 704 can also include additional storage (e.g., removable or non-removable) including, but not limited to, magnetic storage, optical storage, and the like. Such additional storage is illustrated in FIG. 7 by storage 110. In one aspect, computer readable instructions or executable components to implement one or more aspects provided herein can be in storage 110. Storage 110 can also store other computer readable instructions to implement an operating system, an application program, and the like. Computer readable instructions can be loaded in memory 108 for execution by processor 106, for example.

The term “computer readable media” as used herein includes computer storage media. Computer storage media includes volatile and nonvolatile, removable and non-removable media implemented in any method or technology for storage of information such as computer readable instructions or other data. Memory 108 and storage 110 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 704. Any such computer storage media can be part of device 704.

Device 704 can also include communication connection(s) 1026 that allows device 704 to communicate with other devices. Communication connection(s) 1026 can include, but is not limited to, a modem, a Network Interface Card (NIC), an integrated network interface, a radio frequency transmitter/receiver, an infrared port, a USB connection, or other interfaces for connecting computing device 704 to other computing devices. Communication connection(s) 708 can include a wired connection or a wireless connection. Communication connection(s) 708 can transmit or receive communication media.

The term “computer readable media” can also include communication media. Communication media typically embodies computer readable instructions or other data that can be communicated in a “modulated data signal” such as a carrier wave or other transport mechanism and includes any information delivery media. The term “modulated data signal” can include a signal that has one or more of its characteristics set or changed in such a manner as to encode information in the signal.

Device 704 can include input device(s) 712 such as keyboard, mouse, pen, voice input device, touch input device, infrared cameras, video input devices, or any other input device. Output device(s) 710 such as one or more displays, speakers, printers, or any other output device can also be included in device 704. Input device(s) 712 and output device(s) 710 can be connected to device 704 via a wired connection, wireless connection, or any combination thereof. In one aspect, an input device or an output device from another computing device can be used as input device(s) 712 or output device(s) 710 for computing device 704.

Components of computing device 704 can be connected by various interconnects, such as a bus. Such interconnects can include a Peripheral Component Interconnect (PCI), such as PCI Express, a Universal Serial Bus (USB), firewire (IEEE 1394), an optical bus structure, and the like. In another aspect, components of computing device 704 can be interconnected by a network. For example, memory 108 can be comprised of multiple physical memory units located in different physical locations interconnected by a network.

Those skilled in the art will realize that storage devices utilized to store computer readable instructions can be distributed across a network. For example, a computing device 714 accessible via network 114 can store computer readable instructions to implement one or more aspects provided herein. Computing device 704 can access computing device 714 and download a part or all of the computer readable instructions for execution. Alternatively, computing device 704 can download pieces of the computer readable instructions, as needed, or some instructions can be executed at computing device 704 and some at computing device 714.

The device 704 can include a data collection and import component 720 communicatively coupled to the computing device 704 or integrated therewith. This enables the system 104 to evolve with the tax codes and aircraft tax laws. As the needs of tax clients change, different data can be collected and presented in taxability status reports identifying aircraft, associated jurisdictions, and other relevant data for historical and current accountability of paid taxes and registration fees. The data collection and import component 720 can be configured to import future third party data (e.g., third party estimations) easily and seamlessly to compliment current offerings. It is important to note the ability for our system to import and accept new data as it becomes relevant and necessary for function.

In an aspect, the data collection and import component 720 can import assessor data as county assessor data or state assessor data, as well as tax assessed data from various other jurisdictions, including state, local, and county jurisdictions. The data collection and import component 720 can import and store assessor data from any county into one shared table or data set in order to cross-check data from various counties across the country. The system 104 can then process this data as a function of determining whether or not an aircraft has paid taxes or registration fees for a given year. Historical and current searches of records can then be analyzed for cross verification of payment/registration for updating any taxability status report being generated. This assessor information can also be utilized in determining missing information resulting from any gap as well as aid in identifying any gap information. As stated previously, the assessor information/data can include identification of aircraft (e.g., tail number, call sign, etc.), make, model, valuations, improvements, maintenance history, maintenance cost, owner address, associated service rentals (e.g., hangar address, towing use / address, other service locations / information), exemption information, duration of storage or location over a period, property description / use (e.g., commercial, private, etc.), or other assessment data at the county level over a given history or current data range.

The data collection and import component 720 can operate to manage the following for a selected year or date range: active flight data as transponder data; active FAA data as part of air traffic control system information, and active assessor data (e.g., by county, state, or otherwise). The data collection and import component 720 can convert / process / calculate the relevant aircraft statistics, such as days at each airport, overnights at each airport, departures and arrivals from each airport, and associated gaps in the FAA data / traffic control system information.

The data collection and import component 720 can generate data collection tables / queries based on different variables or parameters. These can include, but not limited to, manufacturing and maintenance reports, ATRS reports, airport days, a base airport, a base count, aircraft flight times per aircraft, third party collection, aircraft landing total per airport, aircraft departure totals per airport, gaps or mismatches in flight data, gap counts, a combined list of aircraft per airport, a query linking bluebook values to each aircraft, registration data, an airport base summary, list of airports, jurisdictions, assessor data for each year obtained, bluebook data, or the like. The ATRS report can include a table that is generated and maintained from a custom report (e.g., a Crystal report) that sorts, orders and generates flight events to determine initial days before first departure, number of overnights at each departure (provided no gap), and final days following last arrival. The airport days can be a day count calculated by the data collection and import component 720 for each aircraft at each airport visited (through a series of queries that include departure days, arrival days, and non-flight days while preventing overlapping with multiple departures / arrivals in the same day, number of days prior to a first departure (from reported start date), and a number of days after last arrival (to reported end date) using data from the ATRS report data. The base airport can be calculated taking into consideration the airport with the most calculated days for each aircraft. A base count can be calculated stats for each base airport, to include total base legs (or flight paths) in comparison with total legs flown. The component 720 can also perform queries and query aircraft flight times per aircraft from the databases or storage to total flight time per aircraft. Aircraft landings total per airport can be total calculated landings at each airport being generated for each respective aircraft. Aircraft departure totals per airport can be generated for each aircraft associated with a particular jurisdiction, such as by a departure, arrival, maintenance work, sale, residence, owner residence, pilot residence, airport, taxes / registration paid, or other associated activity to the aircraft and the jurisdiction. The gaps can be a calculated or identified total of gaps found in flight data or data in relation to the aircraft being at a particular jurisdiction. A gap count can be the summary data of gaps with respect to total legs or flight paths flown from one point to another. The combined list per aircraft can be the result of a query of the data collection and import component 720 and generated for a particular airport using the calculated base airport, the third party identified base, and the assessor data. A query can also be performed that links the Bluebook values of each aircraft respective of the year being reported, model/make, and year of manufacture (YOM). An airport base summary can be a generated table by the component 720 with a compilation of measurable data for each aircraft that is determined to be based on a selected airport in for the taxability status report or an update thereof. In addition, data can be combined form public FAA registration databases, or combined in a query by the system. An airport list can include airports from an FAA list of airports and respective data. Assessor data can be combined for each year where assessor data was obtained or for each jurisdiction selected by input to the system. Bluebook data can be imported from a bluebook databased. The component or system can further query linking the make/model information found in Bluebook with that listed for each aircraft make/model in the flight data and FAA data. Each of the above variables or parameters can be generated with the taxability status report along with other data based on one or more user inputs via the input device 712, and configured via the data collection and import component 720.

The device 704 can further include a report creation and export component 722 that can produce detailed airport summary reports as a part of a taxability status report that includes aircraft that had evidence of being based in a specific state / county. This includes, but is not limited to, a system calculated factor percentage for each aircraft that helps rank the aircraft with respect to the level of certainty and related evidence associated with each aircraft. The aircraft can be ranked according to confidence scores that are factored based on or in relation to assessor data obtained from a plurality of jurisdictions including city or state jurisdictions. The confidence scores can be generated according to a level of confidence that taxes or registration fees have been paid based on the traffic system control information, transponder data, and assessor data from one or more jurisdictions.

The assessor data can be selected to overlap with the gap data to further give confidence or assess gap information or missing information that may occur in a given tax year, aid in identifying additional gap information not identified, or give evidence of history or activity of taxes or fees paid, along with strengthening valuation estimates. The confidence scores can be determined according to a specific time period (e.g., a tax year, a quarter, or other time frame) for which the assessor data is obtained. A listing of aircraft can be ranked for a jurisdiction or airport based on the confidence scores for whether an aircraft has a tax liability or registration fee liability remaining to be paid or required and be associated with each of the aircraft in one or more states /counties across the selected time period. An updated taxability status report can then be generated with a top tier of aircraft (e.g., top 25% or otherwise), or for each of the one or more states or counties based on the ranking, for example.

The report creation and export component 722 can further create or export databases for FAA registration information including, but not limited to, certificate date, aircraft manufacturer, aircraft model, aircraft year of manufacture, an owner name, or an owner address. This can include calculated years owned, an estimated purchase value, a reported flight time for selected date range, a third party identified base airport for further confirmation and associated statistics (days visited, overnights, departures, arrivals, total flight paths (legs) flown, a calculated base airport, a base leg count, a number of gaps in the flight data, the airport with most landings, first departure airport and date, assessed airport if applicable, a retail value or current market value, pilot residence, etc.). In addition, any maintenance records, maintenance activity, maintenance address, maintenance cost or damage description can be obtained from any one of aircraft mechanic databases. This could assist in valuation and tax assessment confidence to be used or cross-checked with county / state assessor data or other assessor data as a part of determining and comparing confidence scores.

The report creation and export component 722 can further generate taxability status reports according to aircraft, airport, or jurisdiction including state or county with associated aircraft over a period of time or date range (e.g., a tax year, quarter or the other increment). The device 704 can thus operate to produce aircraft/asset specific detail reports to include any one combination or all of information discussed herein, along with images of aircraft, images of flight paths around an identified base airport as a primary location herein, flight activity details for each leg flown, operator information, and other associated FAA ownership information. Other details, such as additional equipment, sales transaction dates and notable tail number changes, and information that specifically characterizes the asset further can also be reflected on this report based on evidence obtained, inferred, or provided via one or more databases and sets of information (e.g., traffic control system (FAA information), transponder information on activity, assessor information from counties / states, etc.).

In an aspect, independent aircraft valuation can be performed by the report creation and export component 722. Such valuation can take into account past records, bluebook values, Vref valuation guides and appraisals, market sales prices and an associated trend (e.g., high/low/average market tiers), as well as third party estimations / evaluations. The results of the valuation can be provided in the taxability status report for indicating an amount of taxes due or assessing future estimated payments, for example.

The device 704 can further include a search customization component 724 to receive user input, select found aircraft and add them to the internal accounts being managed and reported for generation of taxability status reporting. The search customization component 724 can control account management functions. With each account selection, detailed stats for that asset in selected year are saved for future use, management, tracking, and reporting (e.g., via the report creation and export component 722), where automated report management can be exported to documents types such as PDF, Excel, or other particular document type. Additionally, specific tax code functions can be selected for each State/County.

An advantage of the device 704 or the system 104 is that processes can remain consistent to manage millions of flight records per year. In particular, the system 104 can be configured to report on or generate reports for more than one year or other time frame at a time, while also being flexible to accommodate assessor fiscal years that do not follow a typical Jan 1 - Dec 31 standard.

The flight image creation component 726 can further operate to create flight path images without a need to import these from a third-party vendor. Using the data obtained from databases, the flight image creation component 726 can create the flight path tracking and images on a per aircraft, per year basis, or as demanded.

The device 704 / system 104 can thus quickly observe all airports within a selected county using an imported FAA airport database by obtaining traffic control system information, while further tailoring producing reports unique for each State/County. The device 704 / system 104 dynamically changes and adapts to different tax laws in different jurisdictions. In an aspect, the device 704 enables a user client to determine the most important measurements, valuations, dates, documents set forth by the tax codes so that the system 104 has the ability to tailor the services / reports / data to fit the needs of any tax code.

Advantages to the device 704 is being able to analyze what documentation is provided by the aircraft owners to apply the appropriate tax code on a measurement basis (i.e., where an aircraft registers in comparison to where it is physically and habitually located for a specific period of time measured in hours/days/years). Reports can be generated as discussed herein based on a jurisdiction level (e.g., by state or county) reflecting the number of calculated aircraft based in respective state and associated statistics. An aircraft report can be generated that reflects the flight activity for selected year or time frame, along with the associated measurements, parameters, variables, etc., described herein, including producing a highly accurate desktop valuation of an asset using historical sales as well as the above-mentioned factors.

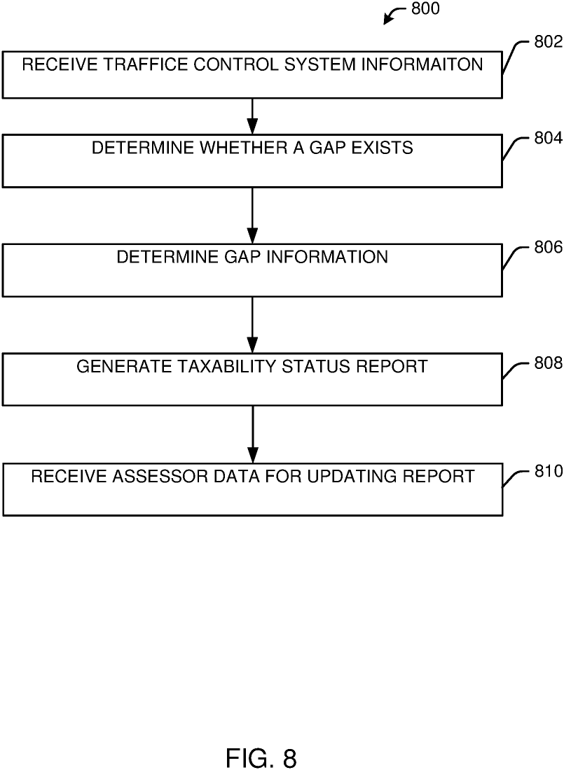

FIG. 8 illustrates a process flow 800 for generating a taxability status report and updating the report with assessor data in accordance with various aspects. At 802, the process flow initiates with receiving traffic control system information associated with the aircraft from a first database or storage. At 804, the device 704 or system 104 can determine whether a gap between a departure and an arrival of the aircraft is in the traffic control system information. The gap can be missing information or a mismatch between a departure location of the aircraft and an arrival location of the aircraft that indicates a missing time and a missing location of the aircraft at the airport. At 806, in response to determining a gap is in the traffic control system information, the process flow includes determining the missing time and the missing location based on the transponder data obtained / received. At 808, a taxability status report associated with the aircraft is generated based on the traffic control system information and the transponder information, as well as the missing time and the missing location. At 810, the process flow continues with receiving assessor data associated with a period of time that overlaps with the gap from at least one second database. The assessor data can include tax data associated with the aircraft that is indicative of taxes paid in relation to at least one of the airport, the gap, a state or a county. This enables the taxability status report to then be cross-checked by the device 704 / system 104 with the assessor data to generate an updated taxability status report. The assessor data can be received from a plurality of states or counties or their associated databases as well be associated with an aircraft in question for the report.

In an aspect, device 704 / system 104 can operate to determine a primary location of from among all airports that the aircraft arrived or departed from and least one of: the traffic control system information or the transponder data. Additionally, or alternatively, the device 704 / system 104 can generate a data set of a group or list aircraft for the taxability status report in relation to a particular airport based on a different states or different counties with the assessor data, one or more first primary locations of the aircraft from the traffic control system information, and one or more second primary locations of the aircraft from an amount of time at each airport that the aircraft arrived or departed from based on the transponder data or other information.

The cross check of the taxability status report with the assessor data can be based on confidence scores associated with different airports that the aircraft arrived or departed from. The assessor data can provide indications of taxes paid by the tax data, or a registration of the aircraft, in relation to various states or counties, the airport, the gap, an unaccounted gap, or other jurisdiction. An updated taxability status report can be generated based on the cross-check to indicate or verify a confidence level of the taxes paid in relation to the states or counties, or a registration of the aircraft in relation thereto. The aircraft can further be ranked based on the confidence scores, which indicate a confidence level of taxes paid or the registration associated with each of the plurality of aircraft in a state or a county. The taxability status report can further be updated with one or more flight path image based on the aircraft and a duration of time with the taxability status report of the aircraft and a set of associated activity details, wherein the associated activity details include at least one of: a primary location, each departure and arrival of the aircraft within a range of the primary location including one or more other airports, maintenance locations, maintenance transactions, description of maintenance, a current market valuation of the aircraft, sales transaction dates, or a tail number change.

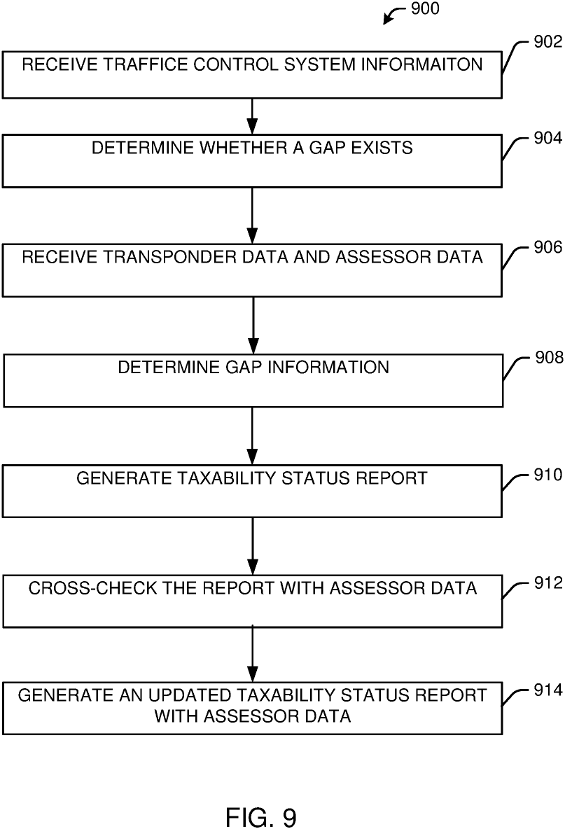

FIG. 9 illustrates another example process flow 900 for generating a taxability status report and updating the report with assessor data in accordance with various aspects. At 902, traffic control system information is received via the system 104 or device 704 associated with an aircraft from a first database. At 904, a determination is made whether a gap occurs between a departure location of the aircraft and an arrival location of the aircraft that indicating a missing time and a missing location of the aircraft at an airport. At 906, transponder data from a transponder mounted on the aircraft can be received by a transceiver positioned in proximity to the airport, which can be from an airport database or other storage, for example. In addition, assessor data associated with a period of time that overlaps with the gap from at least one second database can be received. The assessor data can include tax data associated with the aircraft and indicative of paid taxes or a registration occurring in relation to at least one of a state, a county, the airport, the gap or an unaccounted for gap of information identified by either the transponder data, the assessor data or both. At 908, missing information (gap information) can be determined by the transponder data and the assessor data both. At 910, a taxability status report of the aircraft can be generated based on the traffic control system information and the missing information. At 912 a cross-check of the taxability status report can be performed with the assessor data across a plurality of jurisdictions comprising at least one of: the airport, a state or a county for the aircraft. The assessor data comprises the tax data associated with the aircraft indicative of the paid taxes or the registration in the plurality of jurisdictions. At 914, an updated taxability status report is generated based on the cross-check.

In an aspect, the cross-check of the taxability status report is based on confidence scores associated with various airports that the aircraft arrived or departed from and taxes / registration fees having been paid in an associated jurisdiction. The aircraft can be ranked based on the confidence scores. The confidence scores can indicate a confidence level of the paid taxes or the one or more registrations associated with each of the plurality of aircraft in the state, the county, or the plurality of jurisdictions across a selected time period. Reports for a top tier or threshold of aircraft indicated as not having paid taxes or registrations could be sent to any one of the jurisdictions at a state or local level. Additionally, or alternatively, those having paid could be communicated as well, or all reports could be sent that are associated with each aircraft, and updated on a regular periodic basis.

Each report could further include flight path images around the at least one primary location based on the taxability status report over the period of time for the updated taxability status report. The updated taxability status report comprises associated activity details indicative of the taxes paid. The associated activity details can include a primary location, each departure and arrival of the aircraft within a range of the primary location that includes one or more other airports, one or more maintenance locations, one or more maintenance transactions, a description of maintenance, a current market valuation of the aircraft, one or more sales transaction dates, a tail number change, or other relevant tax / fee information associated with aircraft in a jurisdiction.

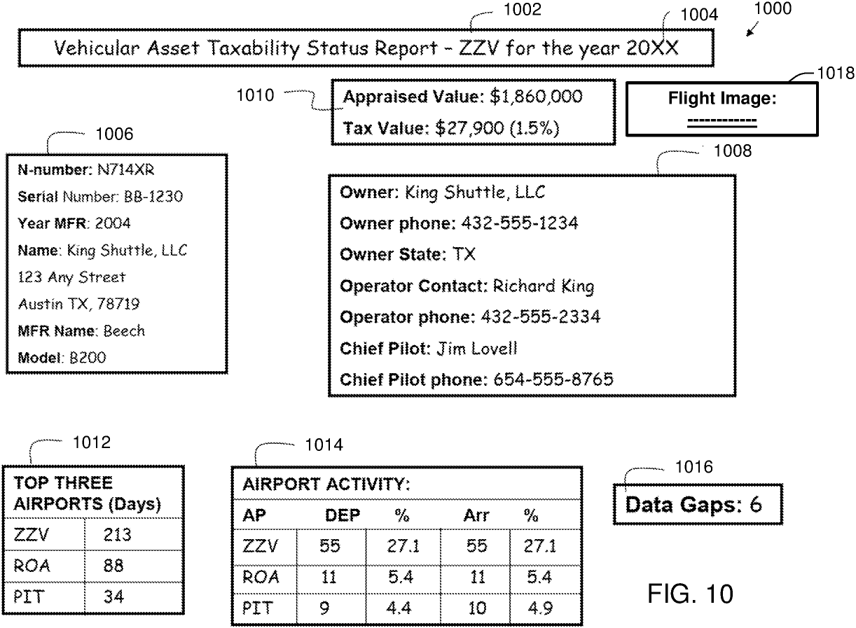

FIG. 10 shows an exemplary vehicular asset taxability status report 1000 in accordance with aspects of the present disclosure. In aspects, the report 1000 can be prepared for a given aircraft, and the tax liability can be assessed for a given airport 1002, for a given tax period 1004.

The report 1000 can include a registration section 1006. In aspects, the registration section 1006 can include, but is not limited to a registration number for the aircraft, a serial number for the aircraft, a manufacture year for the aircraft, a name of the operator, an address of the operator, the manufacturer of the aircraft, or the model of the aircraft.

The report 1000 can include a personnel section 1008. In aspects, the personnel section 1008 can include, but is not limited to an owner name, an owner phone number, an owner state, an operator contact, an operator phone number, a chief pilot name, or a chief pilot phone number.

The report 1000 can include an estimated tax liability section 1010. In aspects, the estimated tax liability section 1010 can include, but is not limited to an appraised value, and a tax value. The appraised value can be determined based on vehicle metadata 118 and vehicle valuation data 120. The tax value can be based on information obtained from legal corpus 130 which can include rules, regulations, tax tables, and other tax information for one or more jurisdictions.

The report 1000 can include a most frequently visited airport section 1012. In aspects, the most frequently visited airport section 1012 can include, but is not limited to the top three airports visited, and the amount of time spent at each of the airports within the tax period.

The report 1000 can include an airport activity section 1014. In aspects, the airport activity section 1014 can include, but is not limited to the number of arrivals and departures at each of the airports listed in most frequently visited airport section 1012. The airport activity section 1014 can further include airports, departures, arrivals and a percentage score.

The report 1000 can include a data gaps section 1016. The data gaps section provides an indication of how many data gaps exist within the tax period of the report. While a few gaps can be expected over the course of a year, if there are too many gaps, then an alert message can be included in the report to call attention to the excessive number of gaps. Thus, aspects include indicating an alert on the report in response to detecting gaps above a predetermined threshold.

In addition to the information shown in FIG. 10, the report can be updated with assessor data, confidence scores of taxes paid, flight images 1018 a variety of additional information can be shown. Furthermore, report generation options can include information organized in numerous ways. Aspects can include data organized by airport or by aircraft. Aspects can include filters that show data only for aircraft that have landed at an airport in excess of a predetermined number of landings. Aspects can include filters that show data only for aircraft that have been hangared at an airport in excess of a predetermined number of days. Aspects can include filters that show data only for aircraft that have traffic control data gaps in excess of a predetermined number of gaps. Other filters and sorting methods are possible to facilitate convenient and effective collection of tax revenue based on aircraft value and itinerary.

As can now be appreciated, disclosed aspects provide improvements in determining a taxability status for a vehicular asset. Vehicles such as aircraft can cost well over a million dollars. As such, the tax liabilities for a jurisdiction can be in the tens of thousands of dollars or more in certain cases. Allowing jurisdictions such as states and counties to recoup some of the tax revenue they are owed can serve to provide funds for airport infrastructure maintenance and improvements. While the aforementioned examples are primarily directed to aircraft, disclosed aspects can be used for other vehicular assets, such as boats, yachts, large shipping vessels, trains, recreational vehicles (RVs), motor homes, and the like.

Although the disclosure has been shown and described with respect to a certain preferred aspects or aspects, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary aspects of the disclosure. In addition, while a particular feature of the disclosure can have been disclosed with respect to only one of several aspects, such feature can be combined with one or more features of the other aspects as can be desired and advantageous for any given or particular application.

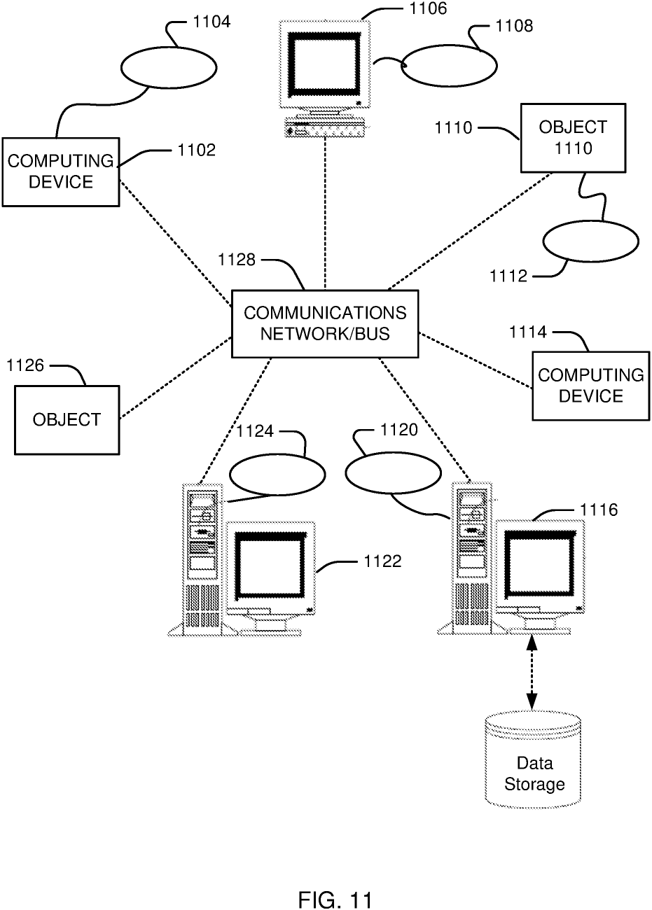

FIG. 11 provides a schematic diagram of an exemplary networked or distributed computing environment that can be integrated with or operate as the system 104 or device 704. The distributed computing environment comprises computing objects 1110, 1126, etc. and computing objects or devices 1102, 1106, 1114, 1116, 1122, etc., which can include programs, methods, data stores, programmable logic, etc., as represented by applications 1104, 1108, 1112, 1120, 1124. It can be appreciated that computing objects 1110, 1126, etc. and computing objects or devices 1102, 1106, 1114, 1116, 1122, etc. can comprise different devices, such as personal digital assistants (PDAs), audio/video devices, mobile phones, MP3 players, personal computers, laptops, etc.

Each computing object 1110, 1126, etc. and computing objects or devices 1102, 1106, 1114, 1116, 1122, etc. can communicate with one or more other computing objects 1110, 1126, etc. and computing objects or devices 1102, 1106, 1114, 1116, 1122, etc. by way of the communications network 1128, either directly or indirectly. Even though illustrated as a single element in FIG. 11, communications network 1128 can comprise other computing objects and computing devices that provide services to the system of FIG. 11, or can represent multiple interconnected networks, which are not shown. Each computing object 1110, 1126, etc. or computing object or device 1102, 1106, 1114, 1116, 1122, etc. can also contain an application, such as applications 1104, 1108, 1112, 1120, 1124, that might make use of an API, or other object, software, firmware or hardware, suitable for communication with or implementation of the shared shopping systems provided in accordance with various non-limiting aspects of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting aspects.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 11, as a non-limiting example, computing objects or devices 1102, 1106, 1114, 1116, 1122, etc. can be thought of as clients and computing objects 1110, 1126, etc. can be thought of as servers where computing objects 1110, 1126, etc., acting as servers provide data services, such as receiving data from client computing objects or devices 1102, 1106, 1114, 1116, 1122, etc., storing of data, processing of data, transmitting data to client computing objects or devices 1102, 1106, 1114, 1116, 1122, etc., although any computer can be considered a client, a server, or both, depending on the circumstances. Any of these computing devices can be processing data, or requesting services or tasks that can implicate the shared shopping techniques as described herein for one or more non-limiting aspects.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1128 or bus is the Internet, for example, the computing objects 1110, 1126, etc. can be Web servers with which other computing objects or devices 1102, 1106, 1114, 1116, 1122, etc. communicate via any of a number of known protocols, such as the hypertext transfer protocol (HTTP). Computing objects 1110, 1112, etc. acting as servers can also serve as clients, e.g., computing objects or devices 1102, 1106, 1114, 1116, 1122, etc., as can be characteristic of a distributed computing environment.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Moreover, various aspects or features described herein can be implemented as a method, apparatus, or article of manufacture using standard programming or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices or other machine-readable media for storing information. The term “machine-readable medium” can include, without being limited to, wireless channels and various other media capable of storing, containing, or carrying instruction(s) or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes or actions of a method or algorithm can reside as one or any combination or set of codes or instructions on a machine-readable medium or computer readable medium, which can be incorporated into a computer program product.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

1-20. (canceled)

21. A system comprising:
a processor; and
a memory that stores instructions that, when executed by the processor, cause the processor to perform acts comprising:
obtaining aircraft location information that is indicative of positions of an aircraft over time, wherein a location of the aircraft at a first time is indeterminate based upon the aircraft location information;
augmenting the aircraft location information with transponder data that is generated based upon a signal transmitted by a transponder mounted on the aircraft, wherein the transponder data is indicative of at least one of altitudes, speeds, or positional coordinates of the aircraft over time;
determining, based upon the augmented aircraft location information, that the aircraft was located at an airport in a first jurisdiction at the first time;
determining that a situs of the aircraft is within the first jurisdiction based upon a situs metric, locations of the aircraft indicated by the augmented aircraft location information, and the aircraft being determined to be located at the airport in the first jurisdiction at the first time; and
outputting a situs report that indicates that the situs of the aircraft is within the first jurisdiction.

22. The system of claim 21, wherein determining that the situs of the aircraft is within the first jurisdiction comprises:
computing, based upon the augmented aircraft location information, a duration of storage of the aircraft at each of a plurality of locations; and
determining that the situs of the aircraft is within the first jurisdiction based upon the duration of storage of the aircraft at each of the plurality of locations.

23. The system of claim 21, wherein the aircraft is a first aircraft, wherein the augmented aircraft location information is indicative of the locations of a plurality of aircraft that includes the first aircraft, the acts further comprising:
determining, based upon augmented aircraft location information, that the plurality of aircraft have situs within the first jurisdiction, wherein the situs report indicates that the plurality of aircraft have situs within the first jurisdiction.

24. The system of claim 21, the acts further comprising:
obtaining assessor data indicative of taxes paid to the first jurisdiction in relation to the aircraft; and
determining, based upon the aircraft being located at the airport at the first time, that additional taxes are payable to the first jurisdiction in relation to the aircraft, wherein the situs report includes an indication of the additional taxes being payable to the first jurisdiction.

25. The system of claim 21, the acts further comprising receiving user input indicative of a period of time, wherein the situs report includes an indication of flight activity of the aircraft during the period of time.

26. The system of claim 25, wherein determining that the situs of the aircraft is within the first jurisdiction comprises determining that the situs of the aircraft is within the first jurisdiction during the period of time indicated by the user input.

27. The system of claim 21, the acts further comprising:
receiving user input indicating a period of time and the aircraft; and
generating an image of flight paths of the aircraft during the period of time based upon the augmented aircraft location information.

28. The system of claim 21, wherein the situs report comprises at least one of:
an estimated valuation of the aircraft;
a base airport of the aircraft; or
an indication of flights flown by the aircraft.

29. The system of claim 21, the acts further comprising:
computing, based upon the augmented aircraft information, a first apportionment share of taxes payable to the first jurisdiction in relation to the aircraft and a second apportionment share of taxes payable to a second jurisdiction in relation to the aircraft.

30. The system of claim 29, wherein the first jurisdiction and the second jurisdiction are counties.

31. The system of claim 29, wherein the first jurisdiction and the second jurisdiction are states.

32. A computer-executable method, comprising:
obtaining first aircraft location information that is indicative of positions of an aircraft over time, wherein a location of the aircraft at a first time is indeterminate based upon the first aircraft location information;
obtaining second aircraft location information that comprises transponder data that is generated based upon a signal transmitted by a transponder mounted on the aircraft, wherein the transponder data is indicative of at least one of altitudes, speeds, or positional coordinates of the aircraft over time;
determining, based upon the second aircraft location information, that the aircraft was located at an airport in a first jurisdiction at the first time;
computing a situs of the aircraft as being within the first jurisdiction based upon a situs metric, the first aircraft location information, and the aircraft being determined to be located at the airport in the first jurisdiction at the first time; and
outputting a situs report that indicates that the situs of the aircraft is within the first jurisdiction.

33. The computer-executable method of claim 32, further comprising:
obtaining valuation data that is indicative of a first valuation of the aircraft; and
computing a second valuation of the aircraft based upon the first valuation and at least one of assessor data pertaining to the aircraft, maintenance history of the aircraft, or operational history of the aircraft, wherein the situs report includes an indication of the second valuation.

34. The computer-executable method of claim 32, further comprising:
obtaining valuation data that is indicative of a market value of the aircraft, wherein the situs report includes an indication of the market value of the aircraft.

35. The computer-executable method of claim 32, further comprising:
computing an apportionment share of taxes attributable to the first jurisdiction based upon the aircraft being located at the airport at the first time and the aircraft being located in a second jurisdiction at a second time.

36. The computer-executable method of claim 32, further comprising:
obtaining assessor data that pertains to the aircraft and is indicative of taxes paid to the first jurisdiction in relation to the aircraft;
determining, based upon the computed situs of the aircraft, that additional taxes are payable to the first jurisdiction in relation to the aircraft, wherein the situs report is indicative of the additional taxes being payable to the first jurisdiction.

37. The computer-executable method of claim 32, wherein computing the situs of the aircraft as being within the first jurisdiction comprises:
computing a number of days within a period of time that the aircraft was located at the airport in the first jurisdiction based upon the aircraft being determined to be located at the airport at the first time; and
determining, based upon the number of days and the situs metric, the situs of the aircraft as being within the first jurisdiction.

38. The computer-executable method of claim 32, wherein the situs report comprises an image of flight paths of the aircraft that include the airport as one of a departure airport or a destination airport.

39. The computer-executable method of claim 32, wherein the situs report comprises a listing of a plurality of aircraft having their respective situses in the first jurisdiction.

40. A computer-readable storage medium storing instructions that, when executed by a processor, cause the processor to perform acts comprising:
obtaining aircraft location information that is indicative of positions of an aircraft over time, wherein a location of the aircraft at a first time is indeterminate based upon the aircraft location information;
obtaining transponder data that is based upon a transponder signal output by a transponder mounted on the aircraft, wherein the transponder data is indicative of at least one of altitudes, speeds, or positions of the aircraft over time;
augmenting the aircraft location information with the transponder data to generate augmented aircraft location information;
determining that a situs of the aircraft is within a first jurisdiction based upon a situs metric, and locations of the aircraft indicated by the augmented aircraft location information, wherein the augmented aircraft location information indicates that the aircraft was located at an airport in the first jurisdiction at the first time; and
outputting a situs report that indicates that the situs of the aircraft is within the first jurisdiction.
